(19) United States
(12) Patent Application Publication
(10) Pub. No.: US 2024/0108161 A1
(43) Pub. Date: Apr. 4, 2024

(54) DRIP COFFEE MAKER WITH ELECTRONICALLY-CONTROLLED VARIABLE VALVE

(71) Applicant: Midea Group Co., Ltd., Beijiao, Shunde, Foshan (CN)

(72) Inventors: Simon Fowler, Louisville, KY (US); Brian Langness, Shelbyville, KY (US)

(21) Appl. No.: 17/937,257

(22) Filed: Sep. 30, 2022

(51) Int. Cl. A47J 31/10; A47J 31/46; A47J 31/52

(52) U.S. Cl. CPC A47J 31/10; A47J 31/461; A47J 31/52

(57) ABSTRACT

A drip coffee maker includes an electronically-controllable variable valve to regulate water/coffee contact time in a brew basket. In some instances, the electronically-controllable variable valve may be movable within a continuous range of positions and may be disposed downstream of the brew basket to regulate the flow rate of coffee produced in the brew basket to a brewing container. In addition, in some instances, the electronically-controllable variable valve may include a valve member that projects through a port and moves along a first axis to vary a fluid flow rate through the port, and a wedge body that moves along a second axis and includes an inclined surface capable of causing movement of the valve member along the first axis in response to movement of the wedge body along the second axis.

### BACKGROUND

Coffee is a beverage made from roasted coffee beans, and has long been one of the most popular drinks in the world. Numerous devices and processes for making coffee have been developed, with most incorporating some variation on bringing water into contact with ground coffee beans to extract water soluble components from the ground coffee beans that give coffee its distinctive taste. However, roasted coffee beans can have numerous soluble components that impart different types of flavors that can be pleasing or displeasing to different palates, so variations in brewing processes can significantly impact the flavor of the resulting coffee.

Two primary types of coffee brewing devices in common use today are generally referred to as espresso machines and drip coffee makers. Espresso machines force hot pressurized water relatively quickly through packed and finely ground coffee beans to generate a highly concentrated, but low volume type of coffee generally referred to as espresso. Drip coffee makers, on the other hand, rely primarily on gravity rather than pressure, and drip heated water onto a brew basket of more coarsely ground coffee beans to allow the water to seep through the coffee grounds to extract the flavor-producing components therefrom. Drip coffee makers also generally incorporate a disposable or reusable filter in the brew basket such that the coffee grounds are retained in the brew basket while the coffee is fed by gravity into a cup or larger container disposed below the brew basket.

Particularly with drip coffee makers, a number of factors can greatly impact a coffee flavor profile, including, for example, the amounts of ground coffee and water that are used, the grind size used to grind the coffee beans, the temperature of the water, and the amount of time the water contacts the ground coffee, among others. Control over water/coffee contact time in a brew basket, for example, is generally based on the rate in which hot water enters the brew basket and the rate in which coffee exits the brew basket. Basic drip coffee makers may control these variables simply through the design of the water supply that supplies heated water to the brew basket and the outlet through which coffee exits the brew basket; however, such designs offer only a single water/coffee contact time that may not be optimal for all types or quantities of coffee, grind sizes, etc.

In addition, some drip coffee makers also include an automatic shut-off valve downstream of the brew basket that is mechanically actuated by removal of a carafe within which the coffee is dispensed to enable a user to pour coffee out of the carafe before the drip coffee brewing operation is complete. Shutting off the dispensing in the middle of a drip coffee brewing operation inherently increases the water/coffee contact time; however, it does so in an unpredictable and uncontrollable manner.

Therefore, a significant need exists in the art for a manner of providing finer grained control over water/coffee contact time in a drip coffee maker.

### SUMMARY

The herein-described embodiments address these and other problems associated with the art by utilizing an electronically-controllable variable valve in a drip coffee maker to regulate water/coffee contact time in a brew basket. In some instances, the electronically-controllable variable valve may be movable within a continuous range of positions and may be disposed downstream of the brew basket to regulate the flow rate of coffee produced in the brew basket to a brewing container. In addition, in some instances, the electronically-controllable variable valve may include a valve member that projects through a port and moves along a first axis to vary a fluid flow rate through the port, and a wedge body that moves along a second axis and includes an inclined surface capable of causing movement of the valve member along the first axis in response to movement of the wedge body along the second axis.

Therefore, consistent with one aspect of the invention, a drip coffee maker may include a brew basket configured to house coffee grounds during brewing, a water supply disposed upstream of the brew basket and configured to supply heated water to the brew basket to bring the heated water into contact with the coffee grounds to perform a drip coffee brewing operation, an electronically-controllable variable valve disposed downstream of the brew basket and movable within a continuous range of positions, and a controller coupled to the electronically-controllable variable valve and configured to regulate a flow rate of coffee produced in the brew basket to a brewing container by controlling the electronically-controllable variable valve within the continuous range of positions.

Moreover, in some embodiments, the electronically-controllable variable valve includes a valve member projecting through a port and configured to move relative to the port to variably occlude the port and thereby vary a fluid flow rate through the port. Further, in some embodiments, the valve member moves along a first axis and includes a substantially conical portion, the first axis is substantially vertical and the substantially conical portion of the valve member decreases in diameter from top to bottom such that movement of the valve member in a downward direction along the first axis increases occlusion of the port. Also, in some embodiments, the electronically-controllable variable valve includes a valve drive, and the valve drive includes a lead screw drive, a servo motor and slider-crank linkage, or a linear actuator.

Further, in some embodiments, the electronically-controllable variable valve includes a valve member projecting through a port and configured to move along a first axis to vary a fluid flow rate through the port, a wedge body configured for movement along a second axis and including an inclined surface operably coupled to the valve member to cause movement of the valve member along the first axis in response to movement of the wedge body along the second axis, and a valve drive operably coupled to the wedge body to controllably-position the wedge body along the second axis and thereby control a position of the valve member along the first axis.

Consistent with another aspect of the invention, a drip coffee maker may include a brew basket configured to house coffee grounds during brewing, a water supply disposed upstream of the brew basket and configured to supply heated water to the brew basket to bring the heated water into contact with the coffee grounds during a drip coffee brewing operation, and an electronically-controllable variable valve positioned to regulate water/coffee contact time in the brew basket. The electronically-controllable variable valve includes a valve member projecting through a port and configured to move along a first axis to vary a fluid flow rate through the port, a wedge body configured for movement along a second axis and including an inclined surface operably coupled to the valve member to cause movement of the valve member along the first axis in response to movement of the wedge body along the second axis, and a valve drive operably coupled to the wedge body to controllably-position the wedge body along the second axis and thereby control a position of the valve member along the first axis.

In some embodiments, the electronically-controllable variable valve further includes a bias mechanism that biases the valve member towards a fully closed position along the first axis at which fluid flow through the port is inhibited. Also, in some embodiments, the electronically-controllable variable valve further includes a bias mechanism that biases the valve member towards a fully open position along the first axis at which fluid flow through the port is maximized. In some embodiments, the valve member includes a substantially conical portion. Further, in some embodiments, the first axis is substantially vertical and the substantially conical portion of the valve member decreases in diameter from top to bottom such that movement of the valve member in a downward direction along the first axis increases occlusion of the port.

Some embodiments may also include a lift body having a mating surface that engages the inclined surface of the wedge body, the lift body being movable along the first axis and positioned intermediate the wedge body and the valve member to cause the movement of the valve member along the first axis in response to movement of the wedge body along the second axis. In some embodiments, the lift body includes a lifting surface configured to contact the valve member to cause the movement of the valve member along the first axis. Further, in some embodiments, the valve member has an outlet configured to output fluid received by the valve member through the port, and the lift body includes a channel configured to allow the fluid output by the outlet of the valve member to travel through the lift body. Also, in some embodiments, the lift body includes a fluid outlet configured to output the fluid received in the channel of the lift body to be conveyed to a container.

In addition, in some embodiments, the wedge body includes an interior opening configured to receive the channel of the lift body, and the interior opening has a length along the second axis that is sufficient to allow the channel to project through the interior opening when the electronically-controllable variable valve is in each of fully closed and fully open positions. Some embodiments may also include a housing, the valve member is coupled to the brew basket, the lift body and wedge body are disposed in the housing, and the brew basket is removable from the housing, and insertion of the brew basket into the housing aligns the valve member with the lift body and wedge body.

In some embodiments, the valve member includes a mating surface configured to contact the inclined surface of the wedge body. In addition, in some embodiments, the valve member includes a downwardly-facing conical tip that funnels fluid flow to a single point of release. Also, in some embodiments, the downwardly-facing conical tip includes a plurality of through-holes for conveying fluid from the port to the single point of release, and the wedge body includes an interior opening that allows fluid released from the single point of release to flow through the wedge body.

In addition, in some embodiments, the electronically-controllable variable valve is disposed downstream of the brew basket and is movable within the continuous range of positions to regulate a flow rate of coffee produced in the brew basket to a brewing container.

Other embodiments may include various methods for making and/or using any of the aforementioned constructions.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a front elevational view of a drip coffee maker consistent with some embodiments of the invention.

FIG. 2 is a block diagram of an example control system for the drip coffee maker of FIG. 1.

FIG. 3 is a block diagram of various brewing components in a drip coffee maker consistent with some embodiments of the invention.

FIG. 4 is a side cross-sectional view of a brew basket and basket support platform of a drip coffee maker consistent with some embodiments of the invention.

FIG. 5 is a perspective view of a wedge body and lift body used in an electronically-controllable variable valve in the drip coffee maker of FIG. 4.

FIG. 6 is a perspective view of a portion of the basket support platform, the wedge body, the lift body, and a valve drive of the valve illustrated in FIG. 5, when the electronically-controllable variable valve is in a fully closed position.

FIG. 7 is a perspective view of a portion of the basket support platform, the wedge body, the lift body, and a valve drive of the valve illustrated in FIG. 5, when the electronically-controllable variable valve is in a fully open position.

FIG. 8 is an elevational view of a valve member of the electronically-controllable variable valve illustrated in FIG. 5.

FIG. 9 is a top plan view of the valve member of FIG. 8.

FIG. 10 is a bottom plan view of the valve member of FIG. 8.

FIG. 11 is an enlarged cross-sectional view of the valve of FIG. 5, when the electronically-controllable variable valve is in a fully closed position.

FIG. 12 is an enlarged cross-sectional view of the valve of FIG. 5, when the electronically-controllable variable valve is in an intermediate position.

FIG. 13 is an enlarged cross-sectional view of the valve of FIG. 5, when the electronically-controllable variable valve is in a fully open position.

FIG. 14 is a functional view of another electronically-controllable variable consistent with the invention.

FIG. 15 is a perspective view of a valve member and wedge body for another electronically-controllable variable consistent with the invention.

### DETAILED DESCRIPTION

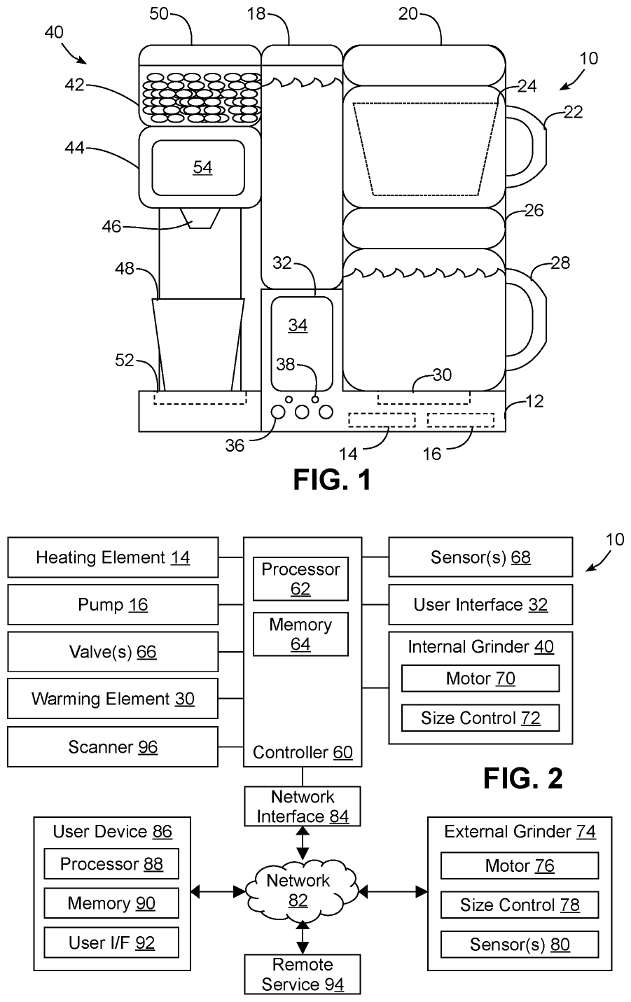

Now turning to the drawings, wherein like parts are denoted by like numbers throughout the several views, FIG. 1 illustrates a drip coffee maker 10 consistent with some embodiments of the invention. Drip coffee maker 10 may include a base or housing 12 within which may be included various components utilized in the brewing of coffee, e.g., a heating element 14, and in some instances, a water pump 16, for heating and conveying water from a water reservoir 18 to a water dispenser 20 disposed above a brew basket 22 within which may be disposed a quantity of ground coffee, and in many instances, a disposable or reusable filter. Brew basket 22 in some embodiments may be removable and/or may incorporate a lid or cover providing access to the brew basket 22 when adding ground coffee and a filter prior to brewing and/or when removing the ground coffee and filter after brewing. In some embodiments, a filter support 24 may be used to support a filter, and the coffee grounds contained therein, during a drip coffee brewing operation. Water dispenser 20 in some embodiments may include a shower head or other suitable mechanism for dispensing heated water evenly across the top surface of the ground coffee disposed in brew basket 22 during brewing.

Disposed beneath brew basket 22 is a coffee dispenser 26 that collects the brewed coffee that passes through the filter in brew basket 22 to dispense the brewed coffee into a container via gravity feed, e.g., a carafe 28, which is some instances may be a glass carafe or a thermal carafe, although brewing may be permitted into other types of containers, e.g., mugs or cups. Coffee dispenser 26 may, in some instances, also include an automatic shut-off valve that shuts off dispensing during a brewing operation if the carafe is removed by a consumer. In some instances, a warming element 30 may also be provided in order to maintain a desirable coffee temperature after brewing.

A user interface 32, e.g., including a graphical and/or touchscreen display 34, one or more physical controls 36 (e.g., buttons, knobs, sliders, etc.) and/or one or more indicators 38 (e.g., lights, alphanumeric displays, etc.), may also be disposed on base 12 to enable a user to interact with the drip coffee maker 10.

In some embodiments, a coffee grinder 40 may also be integrated with and/or interfaced with drip coffee maker 10. Coffee grinder 40, for example, may be integrally disposed in base or housing 12 in some embodiments, while in other embodiments, coffee grinder 40 may be removably coupled to or positionable proximate base or housing 12 and interfaced through one or more wires, one or more contacts, or a wireless network to enable commands and/or data to be communicated therebetween. Coffee grinder 40 may also be powered by drip coffee maker 10 or may be separately powered in various embodiments. In still other embodiments, no coffee grinder may be used, or to the extent a consumer grinds coffee for use with drip coffee maker 10, he or she does so using a completely separate coffee grinder.

Coffee grinder 40 may include a bin or hopper 42 positioned over a burr or blade grinding mechanism 44 that outputs ground coffee from a chute 46 into a container 48. Bin or hopper 42 may also include a lid or cover 50 for allowing for external access to add roasted coffee beans to the bin or hopper. Grinding mechanism 44 may be configured to support variable grind sizes in some embodiments, e.g., through manual or electronically-controlled adjustments to the grinding mechanism. In addition, in some embodiments, a scale 52 may be disposed in coffee grinder 40 to measure the weight of the coffee dispensed through chute 46. User interaction with coffee grinder 40 may be provided through a dedicated interface 54 in some embodiments, while in other embodiments, user interface 32 of drip coffee maker 10 may also control coffee grinder 40.

With further reference to FIG. 2, drip coffee maker 10 may be under the control of a controller 60 that receives inputs from a number of components and drives a number of components in response thereto. Controller 60 may, for example, include one or more processors 62 and a memory 64 within which may be stored program code or instructions for execution by the one or more processors 62. The memory may be embedded in controller 60, but may also be considered to include volatile and/or non-volatile memories, cache memories, flash memories, programmable read-only memories, read-only memories, etc., as well as memory storage physically located elsewhere from controller 60, e.g., in a mass storage device or on a remote computer interfaced with controller 60. Controller 60 may also be implemented as a microcontroller in some embodiments, and as such these terms are used interchangeably herein. Controller 60 may also include discrete circuit logic in some embodiments, e.g., including passive and/or active circuit components.

As shown in FIG. 2, controller 60 may be interfaced with various components, including the aforementioned heating element 14, pump 16, warming element 30, user interface 32, and coffee grinder 40, as well as one or more electronically-controlled valves 66 and one or more sensors 68.

In some embodiments, for example, electronically-controlled valves 66 may be disposed upstream and/or downstream of brew basket 22 to effectively control the amount of time that water contacts the ground coffee in the brew basket. An upstream valve 66, for example, may be used to control the flow of heated water into the brew basket 22. A downstream valve 66 may be used to control the flow of coffee out of brew basket 22 into carafe 28 or another container, and in some embodiments, such a valve may also be fully closeable to prevent coffee from dripping from the brew basket whenever carafe 28 is removed. A downstream valve 66 may also, in some embodiments, enable alternate types of brewing processes, e.g., cold brewing processes where unheated water is steeped in coffee grounds for a relatively long duration. While in some embodiments upstream and/or downstream valves 66 may be used, in other embodiments, no electronically-controllable valves may be used and/or one or both of valves 66 may be mechanically controlled. For the purposes of this disclosure, each of pump 16 and valves 66 may be considered to be a flow control device insofar as each may be used in the control of water flow through the brew basket (i.e., either into the brew basket, out of the brew basket, or both).

A wide variety of different types of sensors 68 may also be used, including for example, temperature sensors, fluid pressure sensors, fluid level sensors, flowmeters, presence sensors (e.g., to detect the proper positioning of a carafe, a brew basket, a water reservoir, a grinder hopper, etc.), position sensors, weight sensors, etc. Other sensors that may be suitable in monitoring the status of and otherwise controlling the operation of drip coffee maker 10 will be appreciated by those of ordinary skill having the benefit of the instant disclosure.

As noted above, where coffee grinder 40 is implemented as an internal coffee grinder, controller 60 may be configured to control various components of the coffee grinder directly, e.g., a motor 70 that drives the grinding process (e.g., by rotating one burr cutting element relative to another burr cutting element), and where electronic control of grind size is supported, a size control 72. Size control in other embodiments may be a manual adjustment.

Alternatively, where drip coffee maker 10 is interfaced with an external coffee grinder (e.g., external coffee grinder 74 of FIG. 2, shown including a motor 76, optional size control 78, and one or more sensors 80), controller 60 may communicate with the external coffee grinder over a network 82 through a network interface 84 to instruct the external coffee grinder to grind coffee, e.g., to grind a desired amount (e.g., based on weight or duration) and/or to grind at a specified grind size.

Network interface 84, for example, may represent one or more network interfaces suitable for interfacing with external devices via wired and/or wireless networks such as Ethernet, Bluetooth, NFC, cellular and other suitable networks. It may also be desirable, for example, to interface with one or more user devices 86, e.g., a consumer's mobile phone, which may include one or more processors 88, a memory 90 and a user interface 92) to enable a customer to control drip coffee maker 10 through the user device 86. It may also be desirable to interface with one or more remote services 94, e.g., to obtain firmware updates, to access remote databases with recipes, coffee bean information, to persist user preferences, to provide maintenance or diagnostic functionality, etc. Moreover, in some embodiments, at least a portion of controller 60 may be implemented externally, e.g., within a mobile device, a cloud computing environment, etc., such that at least a portion of the functionality described herein is implemented within the portion of the controller that is externally implemented.

In some embodiments, controller 60 may operate under the control of an operating system and may execute or otherwise rely upon various computer software applications, components, programs, objects, modules, data structures, etc. In addition, controller 60 may also incorporate hardware logic to implement some or all of the functionality disclosed herein. Further, in some embodiments, the operational sequences performed by controller 60 to implement the embodiments disclosed herein may be implemented using program code including one or more instructions that are resident at various times in various memory and storage devices, and that, when read and executed by one or more hardware-based processors, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized and/or supplemented with other techniques known in the art, and therefore, the invention is not limited to the particular sequences of operations described herein.

It will be appreciated that drip coffee maker 10 may be configured in a wide variety of other manners and may omit one or more of the components discussed above and/or may incorporate other components not explicitly discussed above. For example, as illustrated in FIG. 2, it may be desirable in some embodiments to utilize a bar code or other scanner 96 to enable coffee bean or ground coffee bar codes to be scanned to identify a particular coffee bean or ground coffee being used for a coffee brewing operation and thereby enable the coffee brewing operation to be specifically tailored for a particular coffee bean or ground coffee. Such functionality could also be supported in user device 86, e.g., using a camera of the user device to capture an image of a bar code.

Numerous additional variations and modifications to the drip coffee maker illustrated in FIGS. 1-2 will be apparent to one of ordinary skill in the art, as will become apparent from the description below. Therefore, the invention is not limited to the specific implementations discussed herein.

### Electronically-Controlled Variable Valve

As noted above, in some embodiments, it may be desirable to utilize one or more electronically-controlled variable valves to effectively regulate a water/coffee contact time during a drip coffee brewing operation. A coffee flavor profile can be significantly impacted by the contact time of the coffee grounds with the heated water used for brewing, as well as the uniformity of the extraction of solubles from the coffee grounds throughout the volume of a brew basket, and it has been found that it is difficult to achieve optimal brewing conditions in a brew basket over a large range of serving sizes, grind sizes, and bean roasts, as the geometry, hydraulic resistance, and rate of extraction all generally vary over the range of user determined parameters.

An electronically-controlled variable valve, however, that is moveable between a continuous range of positions, may be used to controllably vary the flow rate into and/or out of a brew basket to minimize the influence of these various parameter changes. Moreover, as will be discussed in greater detail, an electronically-controlled variable valve may be constructed in a space-efficient manner utilizing a wedge body capable of actuating the valve through movement along a different axis from the valve member of the valve.

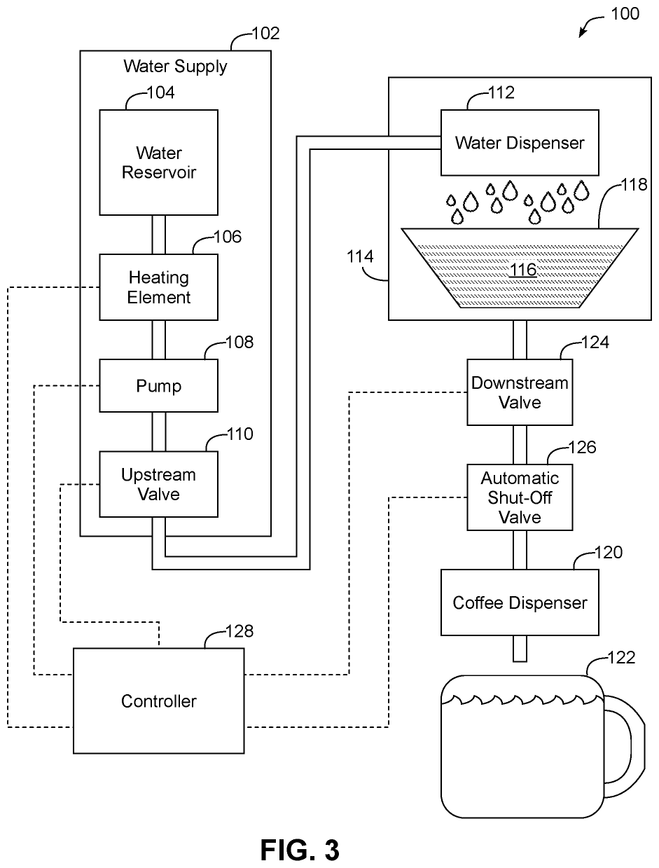

FIG. 3, as an example, illustrates the functional components of a drip coffee maker 100 that includes one or more electronically-controlled variable valves consistent with the invention. Heated water for use in brewing is generated by a water supply 102, which may include a water reservoir 104 (or alternatively, a water line coupled to a water service) that feeds water to a heating element 106 to be heated to a desired temperature. In some embodiments, the temperature may be variable and optimized for a particular drip coffee brewing operation, while in other embodiments, a fixed temperature may be used. Various types of heating elements may be used, including a resistive heating element disposed in a water tank or adjacent a water line. A pump 108 may be used in some embodiments to drive the flow of heated water, while in other embodiments, the heated water may be driven without the use of a pump, e.g., as a result of pressure generated during the heating process.

Water supply may also include an upstream valve 110 that controls the rate of water flow to a water dispenser 112 disposed in a brew basket 114. In other embodiments, however, one or both of pump 108 and upstream valve 110 may be omitted.

Disposed within brew basket 114 during a drip coffee brewing operation may be a quantity of coffee grounds 116 disposed within a disposable or reusable filter 118. Heated water from water supply 102 is dispensed by water dispenser 112 onto the top surface of the coffee grounds 116 to bring the heated water into contact with the coffee grounds to extract solubles from the coffee grounds and thereby brew coffee. Water dispenser 112 may include a shower head or other collection of apertures suitable for distributing water over much of the surface of the coffee grounds, as it is generally desirable to evenly distribute water through the coffee grounds in order to uniformly extract solubles from the coffee grounds.

The coffee may pass through filter 118 and out of brew basket 114 to a coffee dispenser 120, which outputs the brewed coffee to a container 122, e.g., a carafe, cup or mug. In some embodiments, the rate of flow of coffee may be controlled by a downstream valve 124, and in some embodiments, an automatic shut-off valve 126 may be used to shut off coffee flow when no container 122 is positioned below the coffee dispenser 120.

A controller 128 may be used to control one or more of the aforementioned components, e.g., heating element 106, pump 108, upstream valve 110, downstream valve 124 and automatic shut-off valve 126. In the alternative, one or more of these components may be mechanical in nature, and not electronically-controllable. An upstream valve 110 or downstream valve 124 may be manually controllable in some embodiments, and in some embodiments automatic shut-off valve 126 may be mechanically actuated based upon the presence or absence of container 122. Downstream valve 124 and automatic shut-off valve 126 may also be combined in some embodiments, and one or both may be omitted in some embodiments. For example, where downstream valve 124 is electronically-controllable, a pause control operated by a user or a presence detector may be used to trigger a full shut off of downstream valve 124 in some embodiments. In addition, it will be appreciated that coffee dispenser 120 in some embodiments may be integrated into any of brew basket 114, downstream valve 124, and automatic shut-off valve, e.g., implemented as an opening or aperture in one of these components through which coffee may flow.

As noted above, one or both of upstream valve 110 and downstream valve 124 may be implemented using an electronically-controllable variable valve that is capable of being moved within a continuous range of positions to control a flow rate of fluid (e.g., water and/or coffee) through the valve. By controlling one or both of the rate of water entering the brew basket and the rate of coffee exiting the brew basket, the water/coffee contact time may be more precisely controlled, and may be adapted to accommodate different brewing parameters and thereby optimize a drip coffee brewing operation for different scenarios, e.g., different amounts of coffee grounds, different amounts of water, different water temperatures, different grind sizes, different types (e.g., roast levels, brands, models, producers, varieties, etc.) of coffee beans, as well as different user preferences, e.g., to brew stronger or weaker coffee and/or to increase or decrease the extraction or development of the drip coffee brewing operation to emphasize different flavor attributes.

Various valve designs that provide for a continuous range of flow rates may be used in various embodiments, including various types of ball valves, pinch valves, needle valves, etc. Generally, such valves include a valve member that is moveable within a range of positions to variably occlude a port or passageway and thereby vary a flow rate through the port or passageway. In addition, various manners of driving such valves for electronic control may be used, e.g., using servo, stepper, or other types of motors, linear actuators, lead screw drives, or electromagnetic drives capable of relatively accurate positioning.

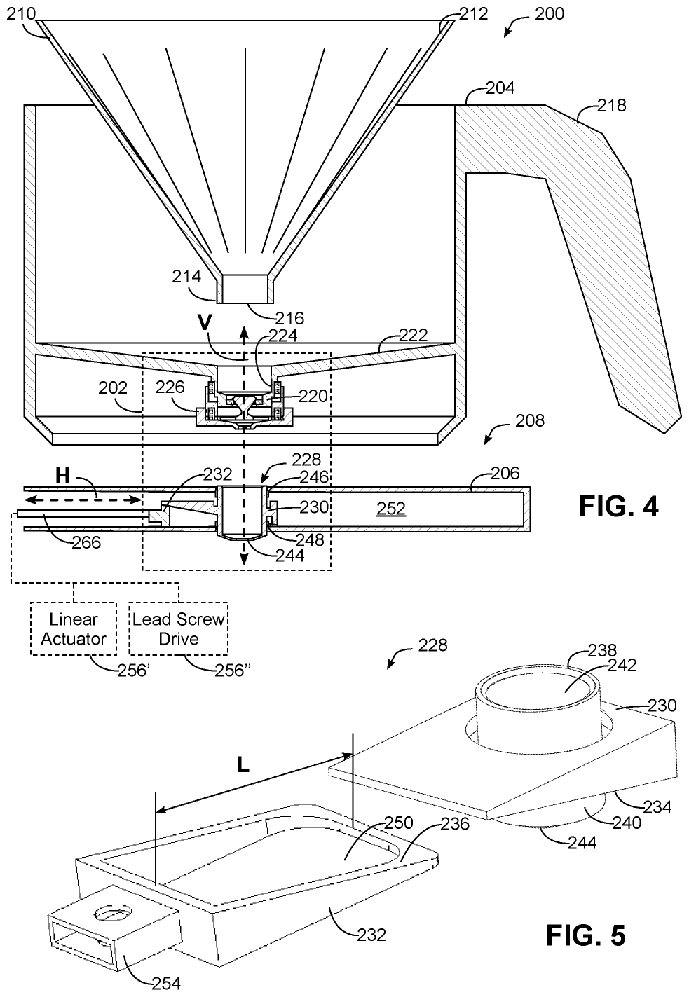

FIG. 4 illustrates a portion of a drip coffee maker 200 that incorporates as a downstream valve an electronically-controllable variable valve 202 that may be utilized in some embodiments of the invention. In this embodiment electronically-controllable variable valve 202 is used to regulate coffee flow out of a brew basket 204 that is removably supported on a basket support platform 206 forming part of a housing 208 of drip coffee maker 200, and as such, portions of the electronically-controllable variable valve 202 are disposed in both brew basket 204 and basket support platform 206, and are aligned with one another when brew basket 204 is properly positioned on basket support platform 206.

In this embodiment, brew basket 204 includes a removable filter support 210 configured to support a filter and coffee grounds (not shown in FIG. 4) during a drip coffee brewing operation. Removable filter support 210 includes a conical wall 212 and a downwardly-extending neck 214 that terminates in an outlet 216 to direct brewed coffee downwardly under the influence of gravity. A handle 218 facilitates insertion and removal of brew basket 204 into and from basket support platform 206. In addition, as filter support 210 is removable, it will be appreciated that multiple filter support designs may be supported in some embodiments, e.g., to accommodate different brew volumes (e.g., different inserts for single cup and full carafe brewing) or different filter geometries. In other embodiments, however, no removable insert may be used, and brew basket 204 may include an integrated and fixed filter support.

Electronically-controllable variable valve 202 in the illustrated embodiment may include a valve body 220 that is integrated into a bottom wall 222 of brew basket 204. In some embodiments, bottom wall 222 may also include a upwardly-facing sleeve 224 that is sized and configured to receive and support neck 214 of removable filter support 210, although it will be appreciated that support of removable filter support 210 may be independent of valve body 220 in other embodiments, and that valve body 220 may be mounted to and/or removable from brew basket 204 in some embodiments.

A valve member 226 is movably coupled to valve body 220 for movement about a substantially-vertical axis V, and a lift assembly 228, which includes a lift body 230 and a wedge body 232, is used to controllably lift valve member 226 to controllably occlude a port 234 in valve body 220. Lift body 230 is configured to move generally along axis V, while wedge body 232 is configured to move generally along a substantially-horizontal axis H, with a downwardly-facing mating surface 234 on lift body 230 engaging an upwardly-facing inclined surface 236 on wedge body 232 such that movement of wedge body 232 along axis H drives movement of lift body 230 along axis V. An upwardly-facing lifting surface 238 on lift body 230 engages with valve body 220 to lift valve body 220 and thereby progressively open electronically-controllably variable valve 202.

With further reference to FIGS. 5-7, lifting surface 238 of lift body 230 is disposed on a tube portion 240 that defines a channel 242 through which coffee may flow to a coffee dispense outlet 244 defined on the bottom of lift body 230. Movement of lift body 230 is constrained to movement generally along axis V by a pair of sleeves 246, 248 formed in top and bottom surfaces of basket support platform 206.

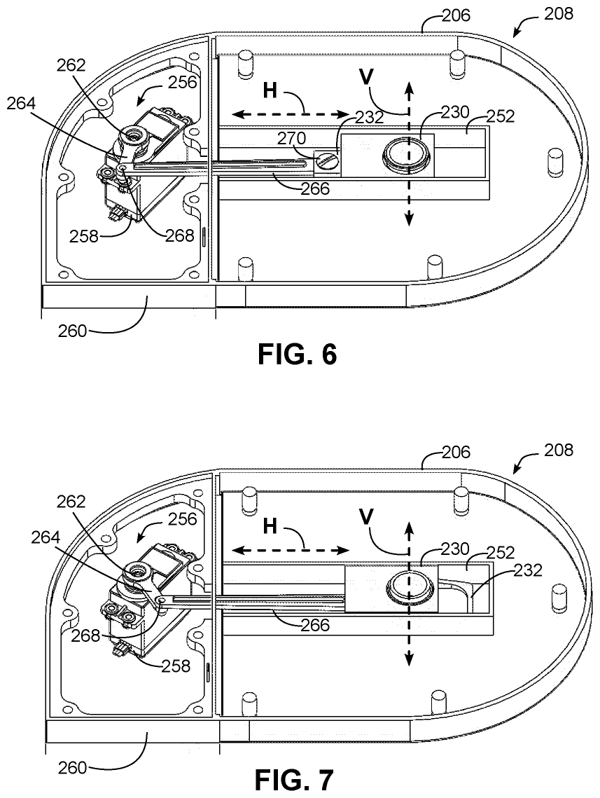

Wedge body 232 also includes an opening 250 that is configured to receive tube portion 240 of lift body 230, and opening 250 has a length L sufficient to accommodate tube portion 240 throughout the full movement of wedge body 232 through its full range of positions along axis H. Wedge body 232 is constrained to movement along the axis H by a slide channel 252 formed in basket support platform 206, and an attachment sleeve 254 is provided on wedge body 232 to engage with a valve drive 256. As shown in FIG. 6, for example, valve drive 256 may include a servo motor 258 that is positioned within a tower portion 260 of housing 208, and a slider-crank linkage, including a driving shaft 262, crank 264, and rod 266. A hinge pin 268 joins crank 264 and rod 266 and a fastener 270 secures rod 266 to wedge body 232 at attachment sleeve 254 to form a second hinge pin in the linkage. As illustrated in FIG. 4, however, other types of valve drives may be used to drive wedge body 232 along axis H, e.g., a linear actuator 256′ or a lead screw drive 256″.

It may be seen that in FIG. 6, which corresponds to a fully closed position of electronically-controllable variable valve 202, wedge body 232 is at its leftmost position along axis H, and lift body 230 is at its lowest position along axis V. As illustrated in FIG. 7, which corresponds to a fully open position of electronically-controllable variable valve 202, rotation of driving shaft 262 of servo motor 258 in a counter-clockwise manner pushes wedge body 232 to the right along axis H, which in turn lifts lift body in an upward direction along axis V. Thus, through actuation of servo motor 258, the position of electronically-controllable variable valve 202 may be precisely controlled within a continuous range of positions between fully open and fully closed positions.

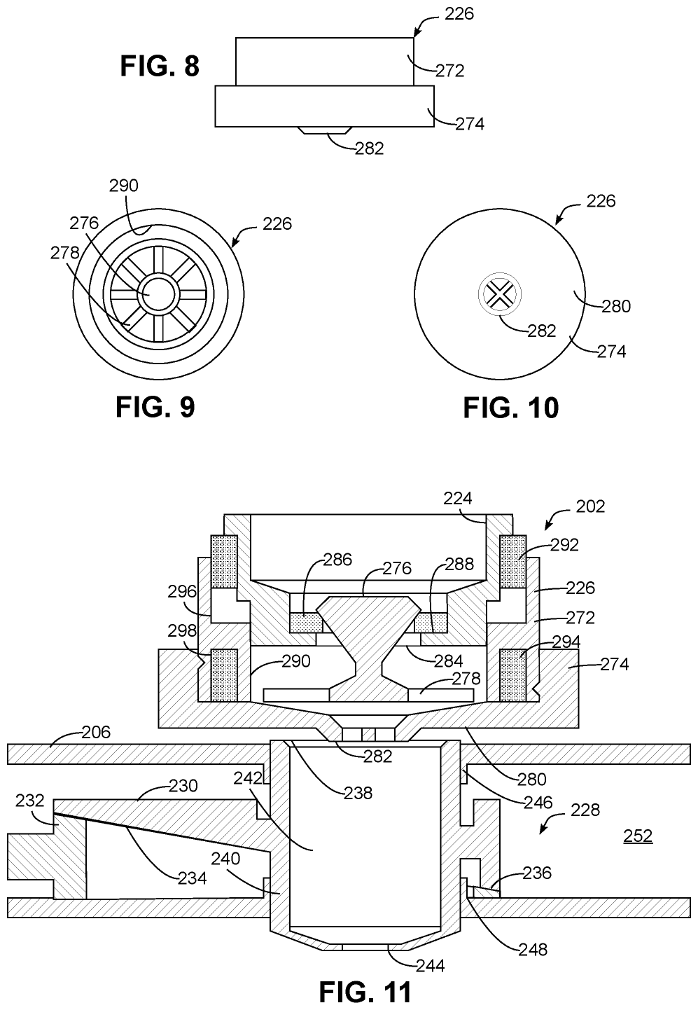

With reference to FIGS. 8-13, valve member 226 in the illustrated embodiment may be of a two piece construction, with first member and second members 272, 274 joined to one another through a threaded coupling. First member 272 includes a substantially conical portion 276 supported by a plurality of radial supports 278 (FIG. 9) that allow for the flow of coffee therethrough, and second member 274 includes bottom surface 280 that engages with lifting surface 238 of lift body 230 and an outlet 282 through which coffee is allowed to flow through the action of gravity (FIG. 10).

Substantially conical portion 276 is configured to project through a port 284 in valve body 220. A gasket, washer or seal 286 is supported on a shoulder 288 of valve body 220 and substantially circumscribes port 284, and substantially conical portion 276 decreases in diameter from top to bottom such that movement of valve member 226 in a downward direction along axis V increases occlusion of port 284 until the substantially conical portion seats onto gasket or seal 286 to fully close port 284. It will be appreciated that electronically-controllable variable valve 202 is functionally similar to a needle valve; however, it will be appreciated that other valve member designs, including a substantially conical portion that decreases in diameter from bottom to top (among other configurations) may be used in other embodiments.

Valve member 226 is constrained for movement along axis V by incorporating a sleeve 290 that receives valve body 220, and a bias mechanism, implemented in the illustrated embodiment by a pair of annular magnets 292, 294 that mutually repel one another, is used to bias valve member 226 in a downward direction and thus towards the closed position for electronically-controllable variable valve 202. A pair of annular slots 296, 298 may be used to support annular magnets 292, 294, respectively

It will be appreciated that electronically-controllable variable valve 202 may be configured as a normally-open valve in other embodiments, and in some embodiments, other bias mechanisms, e.g., magnets that attract rather than repel (as is the case with magnets 292, 294), or one or more springs, may be used to bias an electronically-controllable variable valve to an open or closed position.

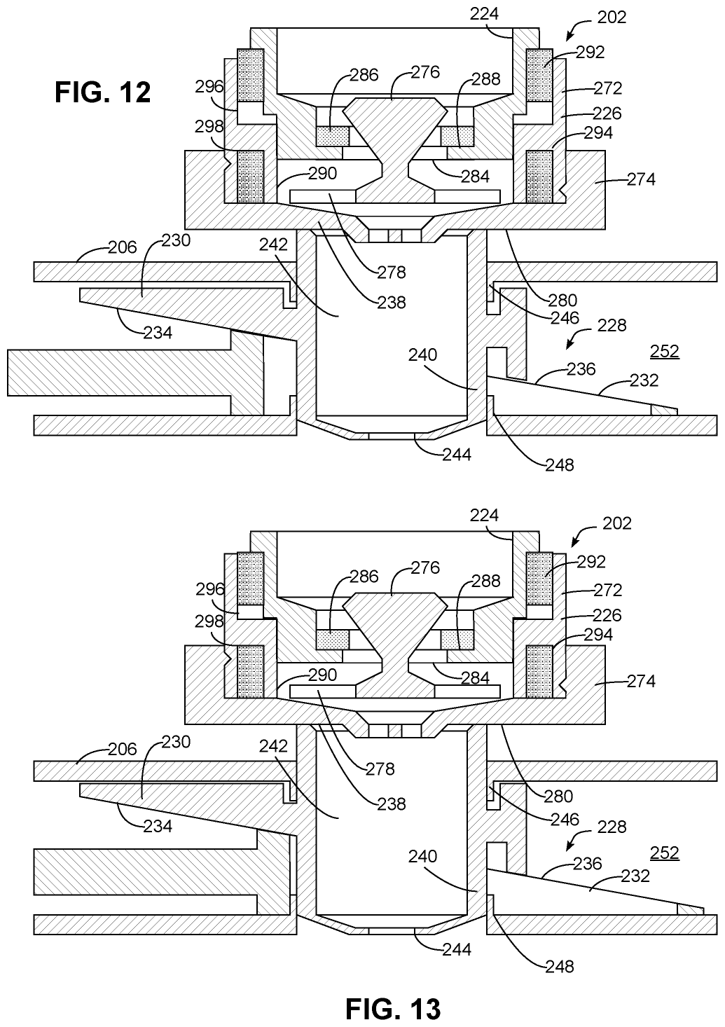

With reference to FIGS. 11-13, these figures illustrate the movement of electronically-controllable variable valve 202 from a fully closed position (FIG. 11) to an intermediate position (FIG. 12) and then to a fully open position (FIG. 13). Movement of wedge body 232 in particular from left to right along axis H pushes lift body 230 upwardly along axis V, resulting in contact between mating surface 234 of lift body 230 and bottom surface 280 of valve member 226, lifting valve member 226 and causing substantially conical portion 276 to move upwardly and progressively open port 284.

It will be appreciated that electronically-controllable variable valve 202 provides a relatively efficient and compact design that is suitable for incorporation into a drip coffee maker, and that further may be well suited for use as an upstream valve in some embodiments. However, a wide variety of other electronically-controllable variable valve designs may be used in other embodiments.

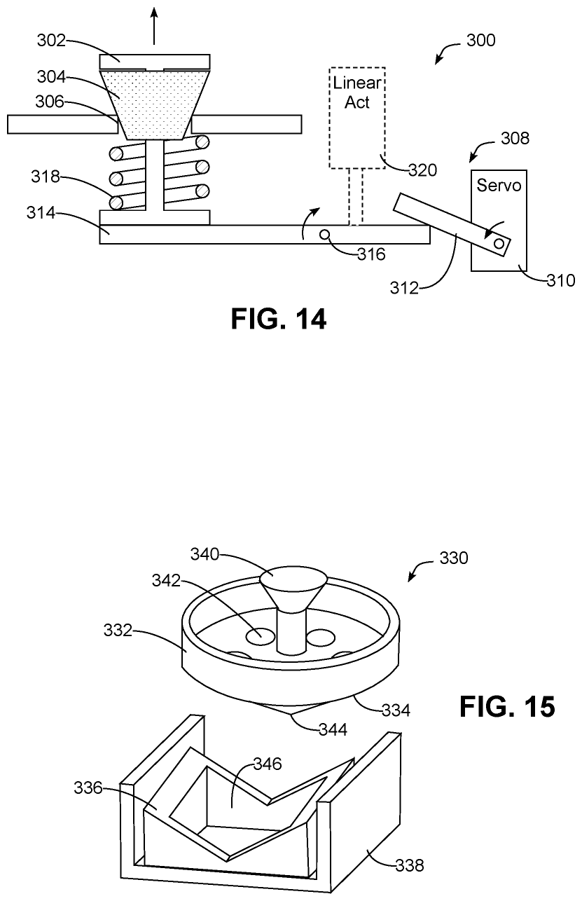

FIG. 14, for example, illustrates at 300 another embodiment of an electronically-controllable variable valve that includes a valve member 302 including a substantially conical portion 304 that projects through a port 306 and is biased to a normally-closed position. Rather than using a slider-crank linkage, however, a valve drive 308 includes a servo motor 310 having a crank 312 that engages a lever 314 that pivots about a pivot point 316 to push valve member 302 upwardly and thereby open the valve.

In addition, rather than utilizing a relatively rigid substantially conical portion that seals against a gasket or seal circumscribing port 306, substantially conical portion 304 may be formed of a pliable material to form the seal. Further, rather than utilizing magnets as a bias mechanism, a spring 318 may instead be used. In addition, in some embodiments, a linear actuator 320 may be utilized instead of a servo motor to control lever 314 and thus the position of valve 300.

FIG. 15 illustrates at 330 another embodiment of an electronically-controllable variable valve that utilizes a valve member 332 that has a mating surface 334 capable of directly engaging or contacting an inclined surface 336 of a wedge body 338, rather than relying on an intermediate lift body. Valve member 332 includes a substantially conical portion 340 and includes a plurality of through-holes 342 that extend to mating surface 334. A conical tip 344 is provided on mating surface 334 to provide a single point of release from which coffee or another fluid that flows through through-holes 342 and along mating surface 334 may smoothly flow into a container. In addition, wedge body 336 includes an interior opening 346 to enable the stream of fluid to flow unimpeded through the wedge body. Similar to electronically-controllable variable valve 202, movement of wedge body 338 along one axis will lift valve member 332 along a different, e.g., a transverse axis, but without an intermediate lift body.

It will be appreciated that, while certain features may be discussed herein in connection with certain embodiments and/or in connection with certain figures, unless expressly stated to the contrary, such features generally may be incorporated into any of the embodiments discussed and illustrated herein. Moreover, features that are disclosed as being combined in some embodiments may generally be implemented separately in other embodiments, and features that are disclosed as being implemented separately in some embodiments may be combined in other embodiments, so the fact that a particular feature is discussed in the context of one embodiment but not another should not be construed as an admission that those two embodiments are mutually exclusive of one another. Various additional modifications may be made to the illustrated embodiments consistent with the invention. Therefore, the invention lies in the claims hereinafter appended.

What is claimed is:

1. A drip coffee maker, comprising:
a brew basket configured to house coffee grounds during brewing;
a water supply disposed upstream of the brew basket and configured to supply heated water to the brew basket to bring the heated water into contact with the coffee grounds to perform a drip coffee brewing operation;
an electronically-controllable variable valve disposed downstream of the brew basket and movable within a continuous range of positions; and
a controller coupled to the electronically-controllable variable valve and configured to regulate a flow rate of coffee produced in the brew basket to a brewing container by controlling the electronically-controllable variable valve within the continuous range of positions.

2. The drip coffee maker of claim 1, wherein the electronically-controllable variable valve includes a valve member projecting through a port and configured to move relative to the port to variably occlude the port and thereby vary a fluid flow rate through the port.

3. The drip coffee maker of claim 2, wherein the valve member moves along a first axis and includes a substantially conical portion, the first axis is substantially vertical and the substantially conical portion of the valve member decreases in diameter from top to bottom such that movement of the valve member in a downward direction along the first axis increases occlusion of the port.

4. The drip coffee maker of claim 1, wherein the electronically-controllable variable valve includes a valve drive, and the valve drive includes a lead screw drive, a servo motor and slider-crank linkage, or a linear actuator.

5. The drip coffee maker of claim 1, wherein the electronically-controllable variable valve includes:
a valve member projecting through a port and configured to move along a first axis to vary a fluid flow rate through the port;
a wedge body configured for movement along a second axis and including an inclined surface operably coupled to the valve member to cause movement of the valve member along the first axis in response to movement of the wedge body along the second axis; and
a valve drive operably coupled to the wedge body to controllably-position the wedge body along the second axis and thereby control a position of the valve member along the first axis.

6. A drip coffee maker, comprising:
a brew basket configured to house coffee grounds during brewing;
a water supply disposed upstream of the brew basket and configured to supply heated water to the brew basket to bring the heated water into contact with the coffee grounds during a drip coffee brewing operation; and
an electronically-controllable variable valve positioned to regulate water/coffee contact time in the brew basket, the electronically-controllable variable valve including:
a valve member projecting through a port and configured to move along a first axis to vary a fluid flow rate through the port;
a wedge body configured for movement along a second axis and including an inclined surface operably coupled to the valve member to cause movement of the valve member along the first axis in response to movement of the wedge body along the second axis; and
a valve drive operably coupled to the wedge body to controllably-position the wedge body along the second axis and thereby control a position of the valve member along the first axis.

7. The drip coffee maker of claim 6, wherein the electronically-controllable variable valve further includes a bias mechanism that biases the valve member towards a fully closed position along the first axis at which fluid flow through the port is inhibited.

8. The drip coffee maker of claim 6, wherein the electronically-controllable variable valve further includes a bias mechanism that biases the valve member towards a fully open position along the first axis at which fluid flow through the port is maximized.

9. The drip coffee maker of claim 6, wherein the valve member includes a substantially conical portion.

10. The drip coffee maker of claim 9, wherein the first axis is substantially vertical and the substantially conical portion of the valve member decreases in diameter from top to bottom such that movement of the valve member in a downward direction along the first axis increases occlusion of the port.

11. The drip coffee maker of claim 6, further comprising a lift body having a mating surface that engages the inclined surface of the wedge body, the lift body being movable along the first axis and positioned intermediate the wedge body and the valve member to cause the movement of the valve member along the first axis in response to movement of the wedge body along the second axis.

12. The drip coffee maker of claim 11, wherein the lift body includes a lifting surface configured to contact the valve member to cause the movement of the valve member along the first axis.

13. The drip coffee maker of claim 12, wherein the valve member has an outlet configured to output fluid received by the valve member through the port, and wherein the lift body includes a channel configured to allow the fluid output by the outlet of the valve member to travel through the lift body.

14. The drip coffee maker of claim 13, wherein the lift body includes a fluid outlet configured to output the fluid received in the channel of the lift body to be conveyed to a container.

15. The drip coffee maker of claim 13, wherein the wedge body includes an interior opening configured to receive the channel of the lift body, wherein the interior opening has a length along the second axis that is sufficient to allow the channel to project through the interior opening when the electronically-controllable variable valve is in each of fully closed and fully open positions.

16. The drip coffee maker of claim 11, further comprising a housing, wherein the valve member is coupled to the brew basket, the lift body and wedge body are disposed in the housing, and the brew basket is removable from the housing, and wherein insertion of the brew basket into the housing aligns the valve member with the lift body and wedge body.

17. The drip coffee maker of claim 6, wherein the valve member includes a mating surface configured to contact the inclined surface of the wedge body.

18. The drip coffee maker of claim 17, wherein the valve member includes a downwardly-facing conical tip that funnels fluid flow to a single point of release.

19. The drip coffee maker of claim 18, wherein the downwardly-facing conical tip includes a plurality of through-holes for conveying fluid from the port to the single point of release, and the wedge body includes an interior opening that allows fluid released from the single point of release to flow through the wedge body.

20. The drip coffee maker of claim 6, wherein the electronically-controllable variable valve is disposed downstream of the brew basket and is movable within the continuous range of positions to regulate a flow rate of coffee produced in the brew basket to a brewing container.
